(19) United States
(12) Patent Application Publication
(10) Pub. No.: US 2012/0122706 A1
(43) Pub. Date: May 17, 2012

(54) ARRAY USING COLOR REACTION OF CHEMICAL COMPOUNDS

(75) Inventor: Hyo-Bong Hong, Daejeon (KR)

(73) Assignee: ELECTRONICS AND TELECOMMUNICATIONS RESEARCH INSTITUTE, Daejeon (KR)

(21) Appl. No.: 13/297,746

(22) Filed: Nov. 16, 2011

(30) Foreign Application Priority Data
Nov. 17, 2010 (KR) 10-2010-0114704

(51) Int. Cl. C40B 30/00; C40B 40/16; C40B 40/04

(52) U.S. Cl. 506/7; 506/15; 506/21

(57) ABSTRACT

Disclosed herein is an array, including a plurality of sensing units, each of which contains a mixture of porphyrin compounds, and which are arranged in a predetermined pattern. The array is advantageous in that it is possible to qualitatively analyze various mixture samples without performing complicated processes of separation and analysis.

### CROSS REFERENCE TO RELATED APPLICATION

This application claims the benefit of Korean Patent Application No. 10-2010-0114704, filed Nov. 17, 2010, which is hereby incorporated by reference in its entirety into this application.

### BACKGROUND OF THE INVENTION

1. Technical Field

The present invention relates to an array using a color reaction of chemical compounds. More particularly, the present invention relates to an array for artificial tastes and smells, which uses a color reaction of chemical compounds.

2. Description of the Related Art

In modern science and industry, it is very important to develop a technology which efficiently detects compounds. It is not an overstatement to say that the advance in chemistry has kept up with the development of analytical equipment or analytical techniques in history. However, recently, mixtures of compounds (not a single compound) are normally analyzed by separating the mixture into compounds, refining the compounds and then qualitatively and quantitatively analyzing each of the compounds. However, this analysis method is problematic in that the characteristics of target substances are partially considered because the errors of analysis and the characteristics of trace substances are not considered at all.

Particularly, in the case of a mixture of various kinds of compounds, such as food, perfume or the like, it is difficult to analyze such a mixture, if it has one characteristic, using the conventional compound analysis method. Therefore, efforts to turn the mixture into a material having one characteristic and analyze the material without respectively separating and analyzing the compounds constituting the mixture have been conducted. In particular, methods of qualitatively analyzing compounds using the color reaction of the compounds with a chromogenic material have been developed.

For example, U.S. Pat. No. 7,261,857 discloses an artificial smell array using porphyrin, and Korean Patent No. 10-0530425 B1 discloses an apparatus for detecting similar gasoline using a dye, and Japanese Patent Application Publication No. 1998-062350 A discloses a method and apparatus for detecting gas using a gas-reactive pigment.

Further, Korean Patent Application Publication No. 2006-0124570 A discloses a water detection composition containing a porphyrin complex compound and an inorganic acid salt as active ingredients and a water detection indicator using the composition.

Further, there was research into a colorimetric sensor for analyzing toxic gases using a metalo-porphyrin, an acid indicator, a basic indicator, a metal salt or the like (Sung H. Lim et al. an optoelectronic nose for the detection of toxic gases. Nature Chemistry, 1, 562-567 (2009.12)).

Furthermore, there was research into an analysis of organics in water using a colorimetric sensor array (Chen Zhang et al. a colorimetric sensor array for organics in water. JACS. 127, 11548-11549 (2005)).

Such technologies are advancing in connection with the development of artificial tastes and smells, and are being spotlighted as technologies which can overcome the disadvantages of artificial tastes and smells, that is, the disadvantage that it is difficult to quantitate and standardize the artificial taste and smell.

However, such a method of analyzing compounds using a color reaction is technically problematic in that materials used in the color reaction are limited, and economically problematic in that an array necessary for precise analysis cannot be fabricated because the materials used in the color reaction are expensive.

### SUMMARY OF THE INVENTION

Accordingly, the present invention has been devised to solve the above-mentioned problems, and the present invention intends to provide an array which can be widely used to analyze foods and environmental pollutants by enabling various color reactions.

Further, the present invention intends to provide a kit which can analyze harmful compounds only by producing a color reaction without using expensive chemical separation and analysis equipment.

Further, the present invention intends to provide a method of analyzing materials, which can expand the objects that can be analyzed and can precisely detect them because a mixture of various kinds of chromogenic compounds is used.

Furthermore, the present invention intends to provide a database (DB) which enables in-situ and on-site analysis of various kinds of harmful compounds.

In order to accomplish the above objects, an aspect of the present invention provides an array, including a plurality of sensing units, each of which contains a mixture of porphyrin compounds, and which are arranged in a predetermined pattern.

Another aspect of the present invention provides a method of analyzing a material using the array.

Still another aspect of the present invention provides a method of analyzing disease-causing factors in respiratory organs and body fluids using the array.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the results of charging a hydrogen peroxide solution into a porphyrin array manufactured according to an example of the present invention, wherein 1-10 represent porphyrin compounds of Table 1 and 1′˜10′ represent mixtures of the porphyrin compounds.

FIG. 2A shows the results of charging water (line B), ethanol (line C), methanol (line D) and fruit juices (line E and F) into a porphyrin array manufactured according to an example of the present invention, wherein line G is a reference containing no sample.

FIG. 2B shows the results of irradiating the porphyrin array with ultraviolet (UV).

FIG. 3 is a graph showing the results of spectroscopic analysis of the reactivity of each sample to the porphyrin compound (I).

### DESCRIPTION OF THE PREFERRED EMBODIMENTS

Hereinafter, preferred embodiments of the present invention will be described in detail with reference to the attached drawings.

The present invention provides an array including a plurality of sensing units, each of which contains a mixture of porphyrin compounds whose colors are changed by the reaction of the porphyrin compounds with specific components, and which are arranged in a predetermined pattern.

In the present invention, “a porphyrin compound” refers to porphine or a porphyrin-metal complex compound.

In an embodiment of the present invention, the array includes a plurality of sensing units containing ten kinds of chromogenic compounds as shown in Table 1 below. All of the chromogenic compounds used in the present invention are porphyrin compounds, but may be mixed with chromogenic materials that react with an acid or a base.

Porphyrin is a material playing an important role in the living body, and is an acidic material having highly conjugated ligands. Therefore, porphyrin has a very dense absorption band in the visible light range, and can exhibit a strong chromogenic effect.

Formula I below represents porphine, which is an unsubstituted porphyrin.

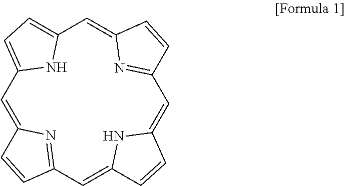

Porphine is characterized in that it bonds with a metal to form a complex compound, and its color changes depending on the kind of metal. Further, porphine is characterized in that the kind of the color reaction thereof changes depending on the kind of metal. Therefore, in the present invention, such characteristics of porphyrin were used to analyze materials.

The color reaction is a procedure of changing the wavelength and intensity of the porphyrin absorption band by covalent interaction or non-covalent solvation interaction between porphyrin and analyzed materials.

However, it is hardly possible to analyze all kinds of existing materials using only the currently-known chromogenic materials. Particularly, in the case of a mixture sample, when the composition ratio thereof is changed, still more kinds of chromogenic materials are required. In order to overcome the above problem, the present invention intends to analyze all kinds of mixtures using only predetermined kinds of chromogenic materials. Porphyrins have different optical properties depending on the mixing ratio thereof. Therefore, when such characteristics of porphyrins are used, it is possible to prepare chromogenic material for almost all kinds of materials.

The mixture of porphyrin compounds which is contained in the array of the present invention may include a complex compound of a metal selected from the group consisting of Mg, Zn, Pt, Fe, Co and Ni, and porphyrin.

Since the array including the mixture of porphyrin compounds according to the present invention shows different color patterns with respect to each target material, when such color patterns are data-based, this data-base can be used to analyze materials, and can be used to develop artificial taste and smell.

Further, the array of the present invention can be used to analyze disease-causing factors in the respiratory organs and body fluids.

Hereinafter, the present invention will be described in more detail with reference to the following Examples. However, these Examples are set forth to illustrate the present invention, and the scope of the present invention is not limited thereto. In the present invention, a diluted hydrogen peroxide solution that is one of bio-markers of pulmonary disease such as chronic obstructive pulmonary disease (COPD), food, acid and the like were selected as experimental target materials and then analyzed. The change of color patterns was definitely ascertained depending on the kind of experimental target material.

### Preparation Example 1

### Method of Manufacturing Porphyrin Array

The kinds of porphyrin compounds used in the experiment are shown in Table 1 below. These porphyrin compounds are manufactured by Sigma-Aldrich Corporation. 0.5 g of the provided porphyrin compound was weighed and then dissolved in 5 mL of reagent grade acetone to prepare a porphyrin compound solution. The prepared porphyrin compound solution was charged into 96-well plates for measuring UV transmission, manufactured by Corning Corp., by 50 μl. Subsequently, two kinds of porphyrin compounds were selected, mixed with each other at a mixing ratio of 1:1 by weight, dissolved in acetone to prepare a porphyrin compound mixture solution, and then the porphyrin compound mixture solution was charged to into the 96-well plates by 50 μl.

TABLE 1

| No. | Porphyrin compounds |
|---|---|
| 1 | 4,4′,4″,4″′-(porphine-5,10,15,20-tetrayl)tetrakis(benzoic acid) |
| 2 | 5,10,15,20-tetraphenyl-21H,23H-porphine manganese(III) chloride |
| 3 | 2,3,7,8,12,13,17,18-octaethyl-21H,23H-porphine manganese(III) |
| | chloride |
| 4 | 5,10,15,20-tetraphenyl-21H,23H-porphine zinc |
| 5 | protoporphyrin IX zinc(II) |
| 6 | platinum octaethylporphyrin |
| 7 | 5,10,15,20-tetrakis(pentafluorophenyl)-21H,23H-porphyrin |
| | iron(III) chloride |
| 8 | 2,3,7,8,12,13,17,18-octaethyl-21H,23H-porphine cobalt(II) |
| 9 | 2,3,7,8,12,13,17,18-octaethyl-21H,23H-porphine nickel(II) |
| 10 | 5,10,15,20-tetraphenyl-21H,23H-porphine |

The 96-well plates charged with the porphyrin compound solution or the porphyrin compound mixture solution were left in a hood to volatilize acetone, thus manufacturing a porphyrin array.

### Example 1

### Analysis of Water and Hydrogen Peroxide Solution

Porphyrin compounds and mixtures thereof were charged into 96-well plates as shown in Table 2 below to manufacture a porphyrin array.

Water was respectively charged into lines A and E of the porphyrin array.

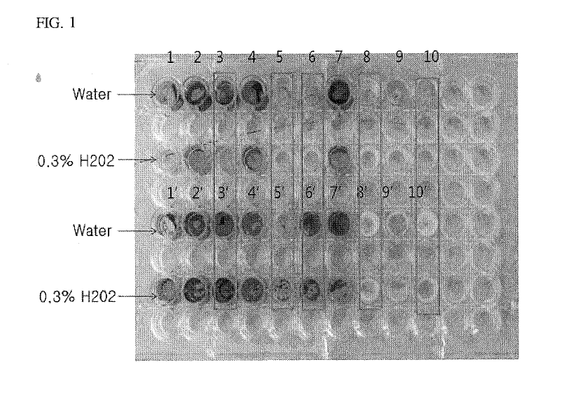

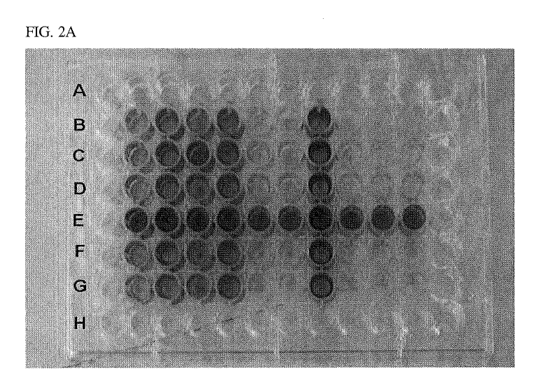

Further, a 0.3% hydrogen peroxide solution obtained by diluting 30% H₂O₂ with distilled water was respectively charged into lines C and G of the porphyrin array. As a result, as shown in FIG. 1, it can be ascertained that, although color reactions changed depending on the kind of porphyrin compounds, when the mixture of the porphyrin compounds was used, various color reactions took place compared to when each of the porphyrin compounds was used.

TABLE 2

| | Row | | | | | | | | | | | |
|---|---|---|---|---|---|---|---|---|---|---|---|---|
| Line | 1 | 2 | 3 | 4 | 5 | 6 | 7 | 8 | 9 | 10 | 11 | 12 |
| A | 1* | 2 | 3 | 4 | 5 | 6 | 7 | 8 | 9 | 10 | — | — |
| B | — | — | — | — | — | — | — | — | — | — | — | — |
| C | 1 | 2 | 3 | 4 | 5 | 6 | 7 | 8 | 9 | 10 | — | — |
| D | — | — | — | — | — | — | — | — | — | — | — | — |
| E | 1 + 10** | 2 + 9 | 3 + 8 | 4 + 7 | 5 + 6 | 6 + 7 | 7 + 8 | 8 + 9 | 9 + 10 | 10 + 2 | — | — |
| F | — | — | — | — | — | — | — | — | — | — | — | — |
| G | 1 + 10 | 2 + 9 | 3 + 8 | 4 + 7 | 5 + 6 | 6 + 7 | 7 + 8 | 8 + 9 | 9 + 10 | 10 + 2 | — | — |
| H | — | — | — | — | — | — | — | — | — | — | — | — |

*Number of porphyrin used
**Numbers of two kinds of porphyrins used

### Example 2

### Analysis of Mixture and the Like

Porphyrin compounds and mixtures thereof were charged into 96-well plates as shown in Table 2 below to manufacture a porphyrin array.

Line B of the porphyrin array was charged with water, the line C thereof was charged with ethanol, the line D thereof was charged with methanol, and the lines E and F thereof were discharged with fruit juices, respectively. As the target materials, commercially available foods and drinks were directly used as undiluted solutions. The line G thereof is a reference containing no sample.

TABLE 3

| | Row | | | | | | | | | | | |
|---|---|---|---|---|---|---|---|---|---|---|---|---|
| Line | 1 | 2 | 3 | 4 | 5 | 6 | 7 | 8 | 9 | 10 | 11 | 12 |
| A | — | — | — | — | — | — | — | — | — | — | — | — |
| B | — | 1* | 2 | 3 | 4 | 5 | 6 | 7 | 8 | 9 | 10 | — |
| C | — | 1 | 2 | 3 | 4 | 5 | 6 | 7 | 8 | 9 | 10 | — |
| D | — | 1 | 2 | 3 | 4 | 5 | 6 | 7 | 8 | 9 | 10 | — |
| E | — | 1 | 2 | 3 | 4 | 5 | 6 | 7 | 8 | 9 | 10 | — |
| F | — | 1 | 2 | 3 | 4 | 5 | 6 | 7 | 8 | 9 | 10 | — |
| G | — | 1 | 2 | 3 | 4 | 5 | 6 | 7 | 8 | 9 | 10 | — |
| H | — | — | — | — | — | — | — | — | — | — | — | — |

*Number of porphyrin used

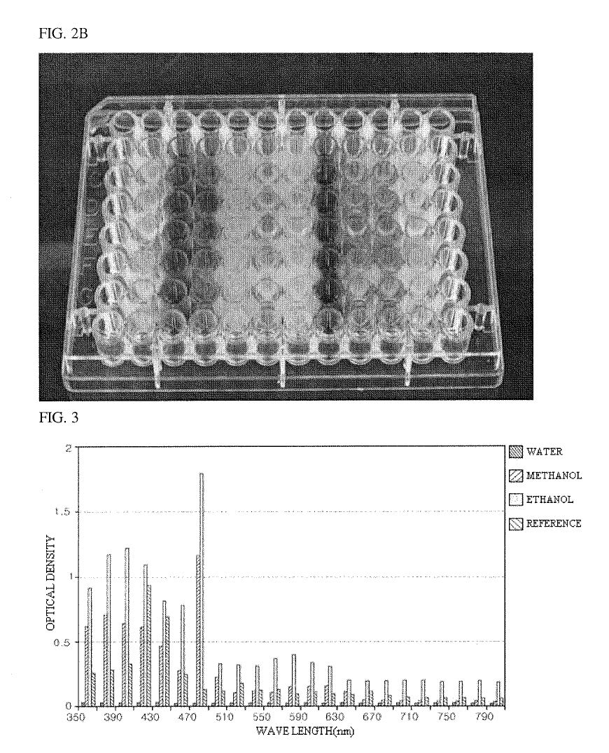

FIG. 3 is a graph showing the result of spectroscopic analysis of the reactivity of each sample to the porphyrin compound (I) using a NanoQuant microplate reader manufactured by Tecan Corporation.

As shown in FIG. 3, it can be ascertained that a wide variety of spectroscopic data can be obtained with respect to one porphyrin compound, and that this spectroscopic data can be used to analyze materials using the array of the present invention.

Still another aspect of the present invention provides a method of analyzing disease-causing factors in respiratory organs and body fluids using the array.

As described above, according to the porphyrin array of the present invention, it is possible to qualitatively analyze various mixture samples without performing complicated processes of separation and analysis. Further, the porphyrin array of the present invention can be used as a kit for detecting various types of poisonous organic materials that comprised in respiratory organs, which is frequently used to diagnose pulmonary diseases. Further, the porphyrin array of the present invention can contribute to the development of industrial analysis equipment because information about various mixtures, which are difficult to taste, can be acquired by this porphyrin array. Furthermore, according to the porphyrin array of the present invention, it is possible to standardize perfumes or tastes, which are difficult to standardize in the food or perfume industries, because color change can be patternized and turned into data by this porphyrin array.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An array, comprising a plurality of sensing units, each of which contains a mixture of porphyrin compounds, and which are arranged in a predetermined pattern.

2. The array according to claim 1, wherein the mixture of porphyrin compounds includes a complex compound of a metal selected from the group consisting of Mg, Zn, Pt, Fe, Co and Ni, and porphyrin.

3. The array according to claim 1, wherein the mixture of porphyrin compounds is a mixture of two or more porphyrin compounds selected from the group consisting of 4,4′,4″, 4′″-(porphine-5,10,15,20-tetrayl)tetrakis(benzoic acid), 5,10,15,20-tetraphenyl-21H,23H-porphine manganese(III) chloride, 2,3,7,8,12,13,17,18-octaethyl-21H,23H-porphine manganese(III) chloride, 5,10,15,20-tetraphenyl-21H,23H-porphine zinc, protoporphyrin IX zinc(II), platinum octaethylporphyrin, 5,10,15,20-tetrakis(pentafluorophenyl)-21H,23H-porphyrin iron(III) chloride, 2,3,7,8,12,13,17,18-octaethyl-21H,23H-porphine cobalt(II), 2,3,7,8,12,13,17,18-octaethyl-21H,23H-porphine nickel(II), and 5,10,15,20-tetraphenyl-21H,23H-porphine.

4. The array according to claim 3, wherein the mixture of porphyrin compounds includes two porphyrin compounds at a mixing ratio of 1:1 by weight.

5. The array according to claim 1, wherein the array is an array for artificial tastes and smells.

6. A method of analyzing a material, said method comprising the step of using the array of claim 1.

7. The method according to claim 6, wherein the material is a mixture.

8. The method according to claim 6, wherein chromogenic patterns of porphyrin are changed into data, and this data is used to analyze the material.

9. A method of analyzing disease-causing factors in respiratory organs and body fluids, said method comprising the step of using the array of claim 1.
